(19) United States
(12) Patent Application Publication
(10) Pub. No.: US 2026/0074860 A1
(43) Pub. Date: Mar. 12, 2026

(54) METHODS, ARCHITECTURES, APPARATUSES AND SYSTEMS FOR DATA-DRIVEN USER EQUIPMENT (UE)-SPECIFIC REFERENCE SIGNAL OPERATION

(71) Applicant: InterDigital Patent Holdings, Inc., Wilmington, DE (US)

(72) Inventors: Arman Shojaeifard, London (GB); Mihaela Beluri, Jericho, NY (US); Patrick Tooher, Montreal (CA); Moon-il Lee, Melville, NY (US); Yugeswar Deenoo Narayanan Thangaraj, Chalfont, PA (US); Mohamed Salah Ibrahim, Chesterbrook, PA (US); Ibrahim Hemadeh, Hemel Hempstead (GB); Akshay Malhotra, San Jose, CA (US)

(21) Appl. No.: 19/101,830

(22) PCT Filed: Aug. 7, 2023
(86) PCT No.: PCT/US2023/029631

§ 371 Date: Feb. 6, 2025

Related U.S. Application Data
(60) Provisional application No. 63/395,937, filed on Aug. 8, 2022.

(51) Int. Cl. H04L 5/00

(52) U.S. Cl. CPC H04L 5/0051

(57) ABSTRACT

Procedures, methods, architectures, apparatuses, systems, devices, and computer program products for configuring, selecting, and/or feeding back data-driven UE-specific RS are provided. One method may include a WTRU determining and/or indicating, to a network element (e.g., gNB), data-driven UE-specific RS related information, such as bundling type, RS pattern, RS position, RS density, RS signaling feedback overhead, and/or performance requirements.

### CROSS-REFERENCE TO RELATED APPLICATIONS

This application claims the benefit of U.S. Provisional Application No. 63/395,937 filed Aug. 8, 2022, the contents of which are incorporated herein by reference in their entirety.

### FIELD

Example embodiments described herein may generally relate to the fields of communications, wireless systems and/or software, including, for example, to methods, architectures, apparatuses, systems related to UE-specific reference signal (RS) operation.

### SUMMARY

An embodiment may be directed to a method, which may include receiving, by a WTRU, configuration information indicating a set of parameters for determining a reference signal (RS) configuration and/or a parameter to use within the set, where the set of parameters includes at least two bundling types. The method may also include receiving a transmission using a first RS pattern of a first RS configuration type, and performing one or more measurements on the transmission using the first RS pattern. The one or more measurements may include one or more of: an effective channel matrix for one or more slots or resource blocks, channel estimation accuracy, and/or RS signaling overhead. The method may also include determining a bundling type associated with the RS configuration, based on the set of parameters and/or the one or more measurements, and transmitting a first indication of the determined bundling type.

An embodiment may be directed to a wireless transmit/receive unit (WTRU) having circuitry including any of a processor, memory, transmitter and/or receiver. The circuitry may be configured to receive configuration information indicating a set of parameters for determining a reference signal (RS) configuration and a parameter to use within the set, where the set of parameters include at least two bundling types. The circuitry may be configured to receive a transmission using a first RS pattern of a first RS configuration type, and to perform one or more measurements on the transmission using the first RS pattern. The one or more measurements may include measurements relating to one or more of: an effective channel matrix for one or more slots or resource blocks, channel estimation accuracy, and/or RS signaling overhead. The circuitry may also be configured to determine a bundling type associated with the RS configuration, based on the set of parameters and/or the one or more measurements, and to transmit a first indication of the determined bundling type.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit/receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 illustrates an example demodulation reference signal (DM-RS) pattern;

FIG. 3 illustrates an example multiple input multiple output (MIMO) transceiver chain;

FIG. 4 illustrates an example of joint gNB/UE processing for data-driven UE-specific RS design;

FIG. 5 illustrates an example of AIML-based RS selection; and

FIG. 6 is an example flow diagram of a method, according to one embodiment.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

### Example Communications System

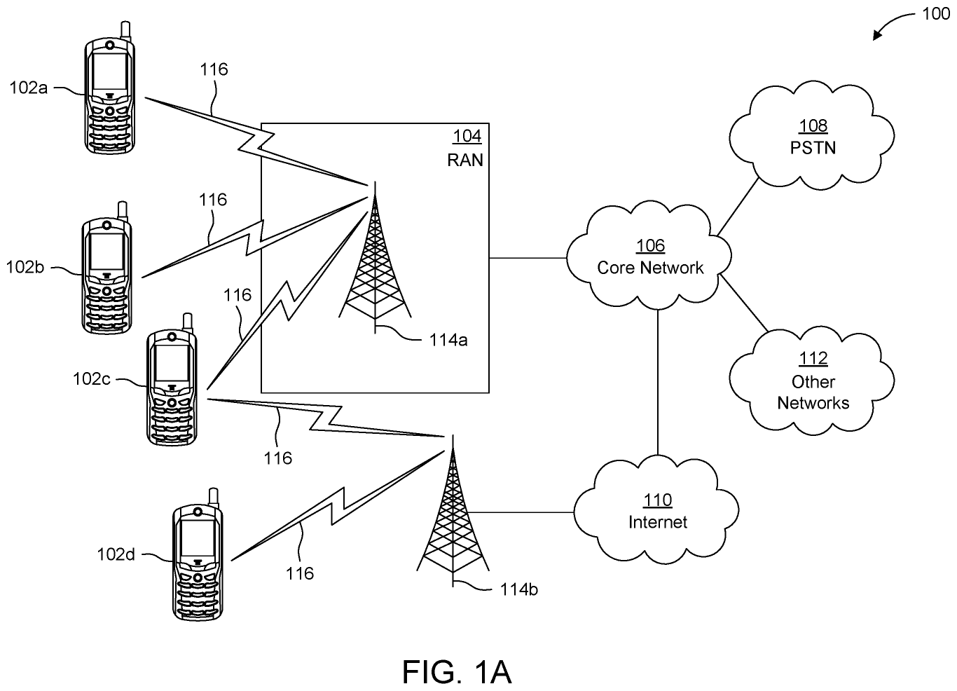

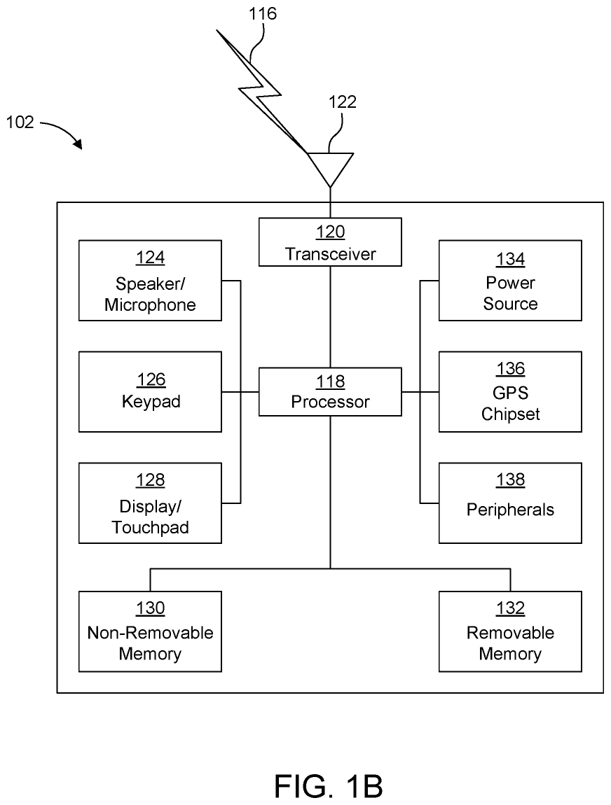

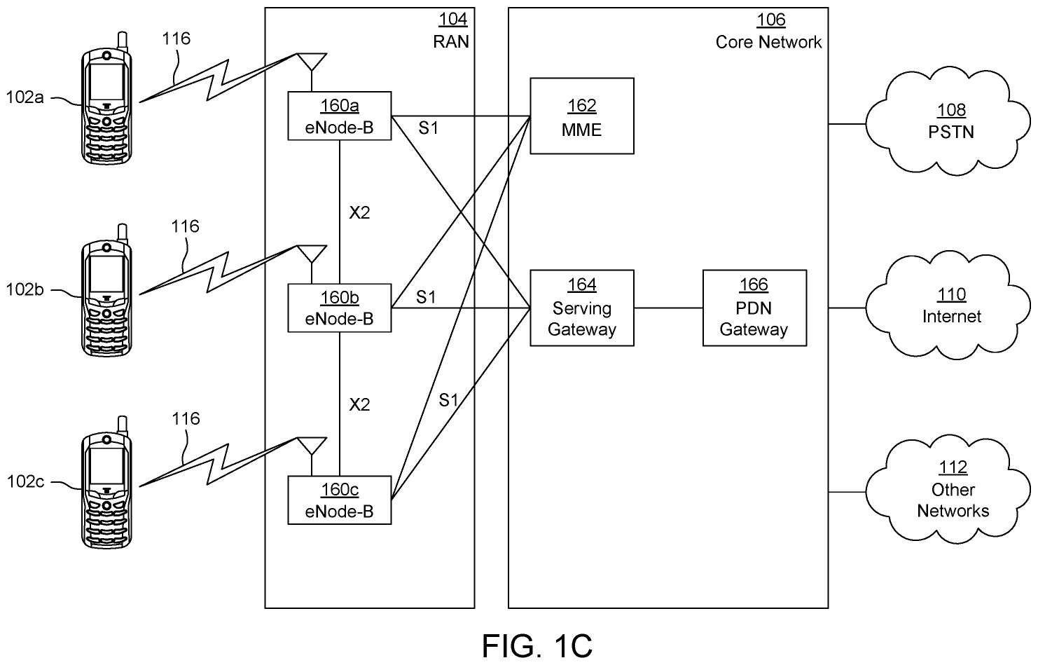

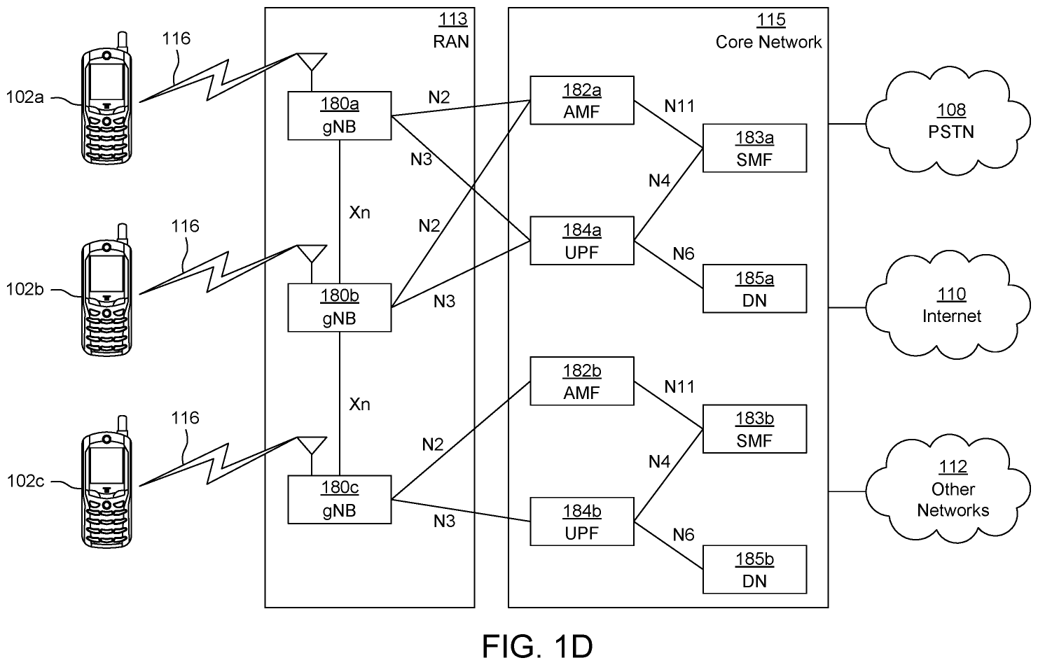

The methods, apparatuses and systems provided herein are well-suited for communications involving both wired and wireless networks. An overview of various types of wireless devices and infrastructure is provided with respect to FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VOIP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an SI interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one session management function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of NAS signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to any of: WTRUs 102a-d, base stations 114a-b, eNode-Bs 160a-c, MME 162, SGW 164, PGW 166, gNBs 180a-c, AMFs 182a-b, UPFs 184a-b, SMFs 183a-b, DNs 185a-b, and/or any other element(s)/device(s) described herein, may be performed by one or more emulation elements/devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

### Introduction

As will be discussed in detail in the following, certain example embodiments may provide at least procedures to configure, select, and/or feedback artificial intelligence (AI)/machine learning (ML)-based data-driven UE-specific RS, for example, including flexible patterns, densities, and/or bundling across time/frequency/space. Some example embodiments may be applicable to RS selection for both DL and/or UL transmissions.

### Overview

In current systems, composite channel estimation (CEST) and coherent demodulation of the precoded/beamformed signals at the receivers is facilitated through transmission of RSs (e.g., demodulation reference signals (DM-RS) and phase tracking reference signals (PTRS)). The RS operation in NR today is static, whereby there exists several predefined options for patterns (uniform/equally spaced) and densities of RSs based on the type of physical channel, configured using scheduling (DCI-based) and high-layer configuration to cater to different use cases and UE capabilities.

Flexible RS operation, such as AIML-based data-driven UE-specific RS design and feedback, allows for a number of benefits, including reduced RS density, reduced RS feedback, reduced receiver (CEST) complexity, improved CEST performance, or a combination of these. In the context of artificial intelligence/machine learning (AIML) for NR Air Interface in Rel-18, RS density reduction using AIML is under study as one of the use cases.

AIML can enable the configuration, selection and feedback of data-driven UE-specific RS operation (such as non-uniform RS patterns, and dynamic bundling across time or/and frequency). The AIML model, e.g., by utilizing channel features such as inherent time/frequency/space correlations across REs, symbols, and antennas, can predict the preferred RS for subsequent DL transmissions and/or uplink transmissions. The AIML processing can be done at the UE side, or jointly between the UE and base station/gNB, whereby there is a compressed preferred RS report or inter-node data exchanged between UE (encoder) and gNB (decoder). Pilotless transmission can be supported as a special case under this framework.

Some example embodiments may include procedures to determine the UE capability (e.g., AIML model) with respect to data-driven UE-specific RS. Certain embodiments may also provide procedures to configure an AIML-capable UE with realization of AIML-based data-driven UE-specific RS, based on UE capability and system performance requirements (e.g., signaling overhead, channel estimation accuracy, RS overhead, etc.). A further embodiment may include procedures to transmit default RS configuration(s) for AIML model training. Some embodiments may also include procedures to determine and/or feedback AIML-based data-driven UE-specific RS operation, which may include joint AIML model processing between gNB/UE. Additionally, certain embodiments may provide procedures to AIML model/channel performance monitoring and triggers for model retraining and reverting to legacy operation.

Coherent demodulation of signals transmitted over the radio interface typically requires knowledge of the (precoded) wireless channel. Channel estimation (CEST) process at the receiver in NR relies on the transmission of physical channels with accompanying reference signals (RS) or pilots.

RSs are generated using pseudo-random sequences based on systems parameters known to the receiver. The parameters used to control the sequence generation include scrambling identity, symbol locations, number of OFDM symbols in a slot, etc. The RS operation in NR today is static, whereby there exists several predefined options for patterns (uniform/equally spaced) and densities of RSs based on the physical channels, configured using scheduling (DCI-based) and high-layer configuration to cater for different use cases and UE capabilities.

The configuration of the DM-RS can include density and pattern in the resource grid, duration, starting symbol (e.g., front-loaded DM-RS), and/or cover codes, to differentiate between antenna ports sharing the same time/frequency resources (for single-user and multi-user MIMO cases). The set of parameters for DM-RS can be different depending on the physical channel and depending on UE capability, e.g., for physical downlink shared channel (PDSCH) DM-RS, there are Configuration Type 1 or Type 2, Mapping Type A or Type B, Starting Symbol for Mapping Type A, Single versus Double Symbol DM-RS, DM-RS Additional Positions, and Duration. It is also possible to group DM-RS over several resource blocks where the precoder is constant such the receiver can perform wideband channel estimation.

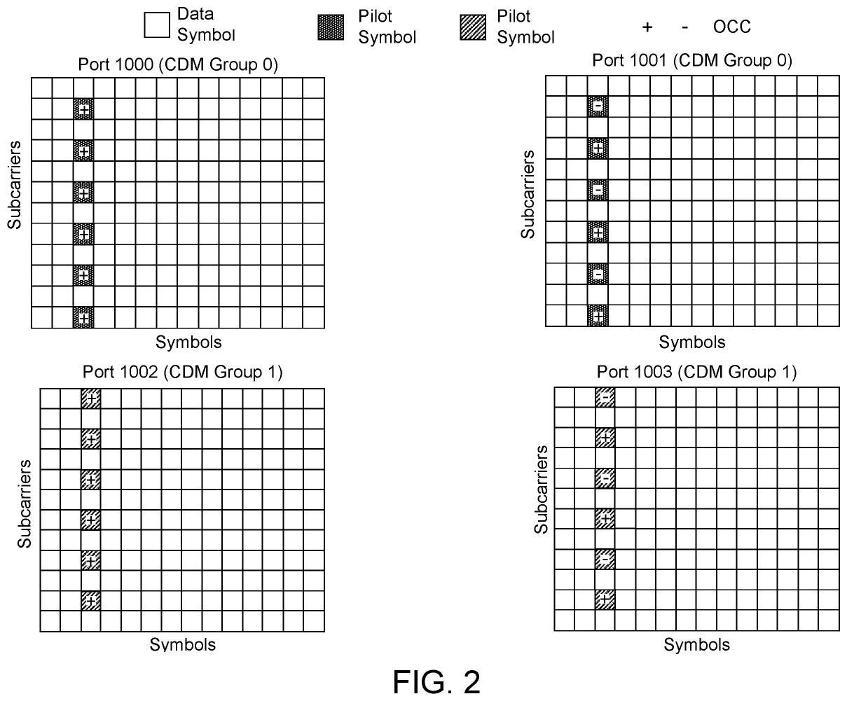

The specific selection of DM-RS can be carried out by both higher-layer configuration and dynamic (DCI-based) signaling, but also there may be cases where there is a default configuration in place. FIG. 2 illustrates an example NR DM-RS single symbol configuration Type 1 for 4×4 MIMO. More specifically, FIG. 2 depicts an example DM-RS pattern over one symbol and one resource block in NR with Configuration Type 1, Mapping Type A, and Starting Symbol 3, using downlink antenna ports 1000-1003, with CDM grouping across the frequency and code domains.

Upon selection of DM-RS settings, the base station can signal (e.g., using RRC, MAC-CE, or PDCCH/DCI) the selection to the terminal (e.g., UE). The terminal may then utilize the DM-RS for CEST and coherent demodulation of the corresponding physical channels. This may be achieved through specific receiver filter implementation (e.g., Least Squares, Minimum Mean Squared Error, etc.) which broadly estimates the composite channel by mapping the transmitted layers onto the receive antennas for the resource blocks that are scheduled.

More specifically, CEST process follows from: (i) the receiver first determines the estimates of the channels of the pilot symbols from their known locations in the received slots, where typically an averaging window is used to minimize the effects of noise; (ii) multidimensional interpolation and extrapolation operations are then used to estimate the missing values from the channel estimation grid; (iii) noise power estimation can be performed to improve performance by comparison of direct and average channel estimates; (iv) with the channel estimate, the terminal then proceeds with coherent OFDM demodulation of precoded/beamformed physical channels.

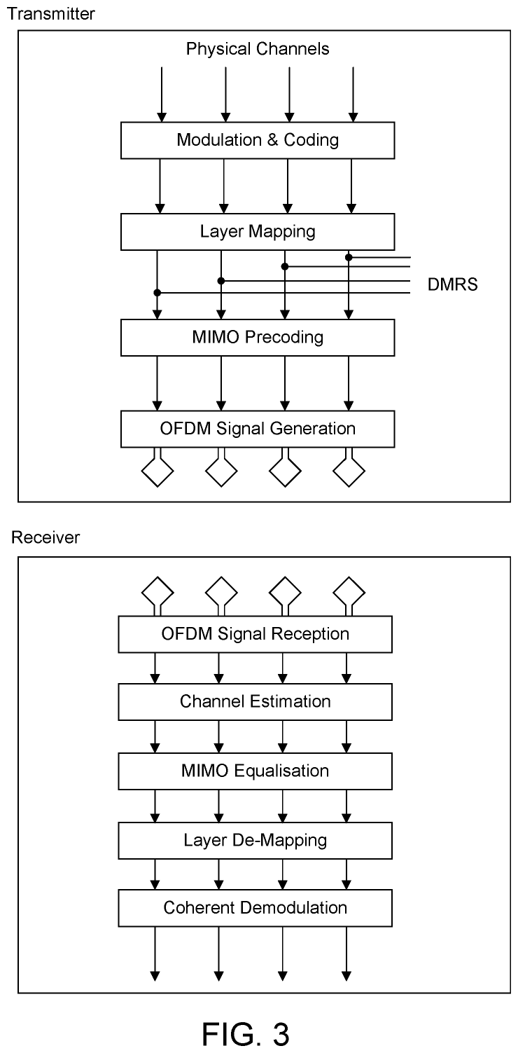

In current NR systems, the reference signal design and CEST are separately designed and operated, as shown in FIG. 3. In particular, FIG. 3 depicts a conventional MIMO transceiver chain with DM-RS inserted at the transmitter side prior to MIMO precoding step.

RS configuration together with the receiver implementation dictates CEST performance: (i) higher density increases CEST accuracy but also overhead, and decreases spectral efficiency, and for MU-MIMO (multi-user multiple-input multiple-output) reduces the scope for spatial-multiplexing; (ii) CEST across a larger number of physical resource blocks (PRBs) improves performance but this “bundling” reduces resolution for frequency-selective precoding; (iii) MU-MIMO requires code division multiplexing (CDM) to differentiate antenna ports sharing the same REs (resource elements), and to increase CDM capability for higher-order MIMO requires adding pilot REs across additional symbols; (iv) with the same density, the positions of pilots on the resource grid impacts receiver computational complexity.

Artificial intelligence (AI) may be broadly defined as the behavior exhibited by machines. Such behavior may e.g., mimic cognitive functions to sense, reason, adapt and/or act.

Machine learning (ML) may refer to types of algorithms that solve a problem based on learning through experience (‘data’), without explicitly being programmed (‘configuring set of rules’). Machine learning can be considered as a subset of AI. Different machine learning paradigms may be envisioned based on the nature of data or feedback available to the learning algorithm. For example, a supervised learning approach may involve learning a function that maps input to an output based on labeled training example, wherein each training example may be a pair consisting of input and the corresponding output. For example, unsupervised learning approach may involve detecting patterns in the data with no pre-existing labels. For example, reinforcement learning approach may involve performing sequence of actions in an environment to maximize the cumulative reward. In some solutions, it is possible to apply machine learning algorithms using a combination or interpolation of the above-mentioned approaches. For example, semi-supervised learning approach may use a combination of a small amount of labeled data with a large amount of unlabeled data during training. In this regard semi-supervised learning falls between unsupervised learning (with no labeled training data) and supervised learning (with only labeled training data).

Deep learning (DL) refers to a class of machine learning algorithms that employ artificial neural networks (e.g., deep neural networks) which were loosely inspired from biological systems. Deep Neural Networks (DNNs) are a special class of machine learning models inspired by the human brain, where the input is linearly transformed and pass-through non-linear activation function multiple times. DNNs typically include multiple layers where each layer consists of linear transformation and a given non-linear activation functions. For example, DNNs can be trained using the training data via a back-propagation algorithm. Recently, DNNs have shown state-of-the-art performance in variety of domains, e.g., speech, vision, natural language, etc. and for various machine learning settings supervised, un-supervised, and semi-supervised. The term AIML based methods or processing may refer to realization of behaviors and/or conformance to requirements by learning based on data, without explicit configuration of sequence of steps of actions. Such methods may enable learning complex behaviors which might be difficult to specify and/or implement when using legacy methods.

Auto-encoders (AE) are a specific class of DNNs that arise in the context of un-supervised machine learning setting wherein the high-dimensional data is non-linearly transformed to a lower dimensional latent vector using the DNN based encoder and the lower dimensional latent vector is then used to re-produce the high-dimensional data using a non-linear decoder. The encoder is represented as E(x; Wₑ)where x is the high-dimensional data and Wₑ represents the parameters of the encoder. The decoder is represented as D(z; W_{d}) where z is the low-dimensional latent representation and W_{d} represents the parameters of the decoder. Further, using training data {x₁, . . . , x_{N}} the auto-encoder can be trained by solving the following optimization problem

$$\{ {W}_{e}^{tr} , {W}_{d}^{tr} \} = arg {min}_{{W}_{e} , {W}_{d}} {\sum }_{i = 1}^{N} {‖ {x}_{i} - D ( E ( {x}_{i} ; {W}_{e} ) ; {W}_{d} ) ‖}_{2}^{2} .$$

The above problem can be approximately solved using a backpropagation algorithm. The trained encoder

$$E ( x ; {W}_{e}^{tr} )$$

can be used to compress the high-dimensional data and trained decoder

$$D ( z ; {W}_{d}^{tr} )$$

can be used to decompress the latent representation.

The terms Artificial Intelligence (AI), Machine Learning (ML), Deep Learning (DL), DNNs may be used interchangeably herein. Methods described herein may be exemplified based on learning in wireless communication systems. However, the methods described herein are not limited to such scenarios, systems and services, and may be applicable to any type of transmissions, communication systems and/or services, etc.

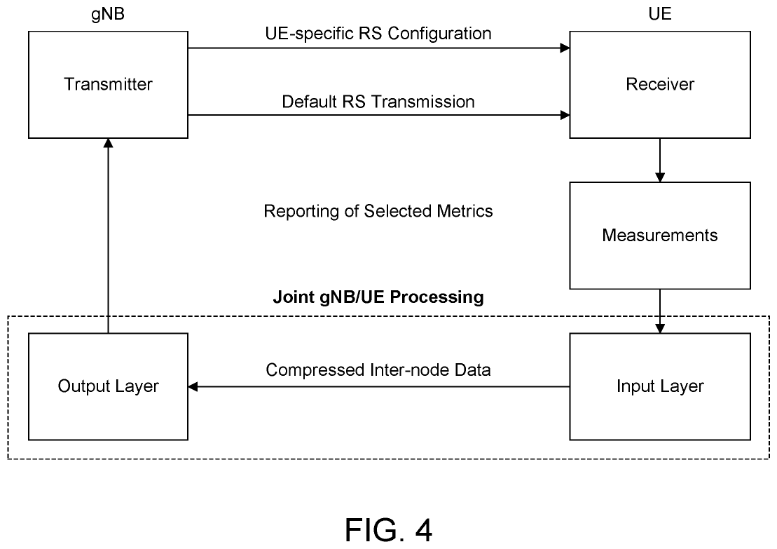

The RS operation in NR may be considered sub-optimal, e.g., due to the static (non-adaptive) configuration of the RS, and more importantly limited set of options in terms of patterns (uniform/equally spaced) and densities over time/frequency/space. Even under the limited options available, determining the best RS configuration is non-trivial. These aspects hence result in under-utilization or over-utilization of radio resources for control. The problem becomes even more challenging for more flexible RS patterns, e.g., identifying the optimal density and position of RS in time/frequency/space across multiple resource blocks and multiple slots. Enabling more flexible RS design is challenging due to several factors including control signaling feedback overhead, lack of model-based optimal solutions (NP-hard problem), and/or UE receiver complexity. Further, there are currently no/limited features for enabling pilot-less transmission of physical channels in NR Flexible RS operation, utilizing channel features such as inherent across time/frequency/space correlations across subcarriers and antennas, can provide reduced density, reduced feedback, reduced receiver complexity, improved performance, or a combination of these. A problem arises as to whether data-driven (AIML based) solutions enable UE, or joint gNB/UE (FIG. 4), to select and feedback data-driven UE-specific RS design, in terms of identifying and signaling of the optimal (and potentially non-uniform) patterns, potentially combined/optimized with CEST process. FIG. 4 illustrates an example of joint gNB/UE processing for data-driven UE-specific RS design. The problem can be viewed as a feature selection task with both prediction and compression, based on channel characteristics such as correlations in time and frequency (utilizing data-driven learning, e.g., NN layers, NN as classifier). Pilotless transmission, resulting in increased spectral efficiency and reduced signaling, can be supported as a special case under this framework.

In view of the foregoing, some example embodiments may provide procedures for the configuring the UE with one or a set of attributes for data-driven UE-specific RS selection and feedback, including RS patten, density, and bundling properties across time/frequency/space, RS control overhead, RS signaling overhead, etc. Configuration options may include the use of non-deterministic pilot patterns, and the use of superimposed pilots (where energy is split between data/pilot symbols).

Some example embodiments may provide procedures for AIML model processing to determine data-driven UE-specific RS, where input may be the effective channel matrices from the resource grids and the output are the flexible RS design based on the configuration involving one or any design attribute combinations and realizations including position/pattern in frequency and time resources, bundling across multiple frequency and time resources, etc.

Some example embodiments may provide procedures for UE feedback, e.g., explicitly, implicitly, or using inter-node data exchange (for AIML joint processing cases), data-driven UE-specific RS design including cases for pilot-less transmission.

Some example embodiments may provide procedures for UE-specific RS design (AIML model) performance monitoring by gNB, UE, or both. The performance monitoring may include monitoring various performance evaluation metrics, e.g., where if below certain threshold, AIML model retraining may be triggered, and in some cases reverting to legacy RS operation.

It is noted that Reference Signal (RS) pattern may be used herein interchangeably with UL or DL DM-RS pattern. Further, an RS pattern or RS configuration may be used interchangeably. In addition, an RS pattern or a parameter of an RS pattern may be used interchangeably. A UE-specific RS configuration may refer to a RS pattern or configuration which is specific to an individual UE.

According to certain embodiments, an AIML model (or alternative data-driven learning) may be trained and used to determine UE-specific RS. For example, the gNB may configure the attributes (and limits) for RS design and feedback, including RS pattern selection parameters across time, frequency and/or space, RS control overhead, and RS signaling overhead. For the AIML model, the input may be the effective channel matrices from the resource grids and the output may be the data-driven UE-specific RS design based on the gNB configuration involving one or any design attribute combinations and realizations including position/pattern in frequency and time resources, bundling across multiple frequency and time resources, etc. The UE may feedback, explicitly, implicitly, or using inter-node data exchange (for AIML joint processing cases), data-driven UE-specific RS design including cases for pilot-less transmission.

According to certain embodiments, different realizations of RS design can be considered depending on UE capability, system requirements, etc. These may impact the UE behavior from configuration, processing, and signaling. Examples of RS designs that may be used, according to certain embodiments, may include one or more of: position/pattern in frequency domain, dynamic resource block bundling, position/pattern in time domain, multi-slot bundling, MU-MIMO, CDM, and legacy operation, non-deterministic pilot patterns, and/or non-orthogonal pilots.

Position/pattern in frequency domain may refer to flexibly allocating REs for pilots in the frequency domain, resulting in different densities, different locations, different scope for frequency multiplexing/CDM. In one example, having additional DM-RS Configuration Types (beyond Type 1 and Type 2), e.g., for PDSCH/PUSCH, a flexible configuration Type X (AIML), where for example in one instance first and last RE in a RS symbol are allocated to pilots, resulting in 16.6% density, versus 50% in Type 1 and 33.3% in Type 2, with support (for single symbol transmission) up to 4 antenna ports if using Orthogonal Cover Code (OCC) for CDM, same as NR Type 1. In one example, a gNB may dictate a maximum and/or a minimum frequency density for pilot transmission, where the AIML processing at the UE, or joint UE/gNB, is used to identify the specific positions on the resource grid.

Dynamic resource block bundling may refer to dynamically configuring the PRB bundling based on the tradeoff between frequency-selective precoding and CEST performance. Increasing PRB bundling size is more applicable to reciprocity-based transmission (where there is no need to quantize CSI feedback into subbands), where also time-domain channel estimation algorithm performance is improved, whereas decreasing PRB bundling size is more suitable for codebook-based transmission. In one example, the AIML model may be used to flexibly decide on the choice of PRB bundling, e.g., using the delay spread indication, where the effective channel is estimated through filtering/averaging DM-RSs (in NR there are options for PRB bundles of two and four, and wideband, configured with higher-layer signaling).

Position/pattern in time domain may refer to flexibly allocating REs for pilots in the time domain, resulting in different densities, different locations, different scope for frequency multiplexing/CDM. In one example, for a given configuration type (i.e., freq. domain setting) multi-symbol configurations are added to support increase the number of available antenna ports towards higher-rank (incl. MU-MIMO) transmissions. In another example, additional mapping type X is included (besides Types A and B), where the AIML model determines the positions of pilots in the time domain, a different approach from the frequency-centric configuration in NR. In one example, a gNB may dictate a maximum and/or a minimum frequency density for pilot transmission, where the AIML processing at UE, or joint UE/gNB, is used to identify the specific positions on the resource grid.

Multi-slot bundling may refer to enabling CHEST across several slots, where the precoder is kept fixed across the slots. This approach can be suited for low-varying channels with large time coherence interval, where the signaling overhead (REs used for pilots) can be reduced, providing more resources for transmission of data symbols. In one example, the AIML model dynamically determines, e.g., using the Doppler spread indication, the number of slots for bundling. This approach also increases applicability of time-domain-based CEST algorithms.

MU-MIMO, CDM, and legacy operation may refer to enabling flexible UE-specific RS configuration for MU-MIMO cases where CDM grouping must be configured at the gNB, following certain feedback from UEs. In one example, the AIML model may utilize a broadcast message to inform UEs for CDM grouping/muting. In another example, a UE may signal the muting pattern to a neighboring UE that is not aware of the grouping. In one example, the scheduler separates legacy vs flexible-RS-capable UEs for MU-MIMO operation.

Non-deterministic pilot patterns may refer to random pilot patterns. It has been shown that random pilot patterns (across time and frequency) are statistically optimal for MMSE receivers, although inducing high complexity, the UE can signal capability for random pilot pattern. Under this approach, the UE may proceed with CEST and generate adaptive feedback regarding next configurations (e.g., in one solution, increase or decrease in time/frequency density).

Non-orthogonal pilots may refer to using superimposed pilots, different from the conventional orthogonality between pilot and data symbols. In one example, the energy for the REs is split between a pilot symbol and a data symbol, and an end-to-end AIML model is used to learn the amount of energy that should be allocated to pilots (i.e., determining a pilot allocation matrix).

### Representative Procedures to Configure UE-Specific RS

According to an embodiment, a gNB may configure the UE with attributes (and possibly limits) for AIML-based data-driven UE-specific RS selection and feedback, e.g., including RS patten and density properties across time/frequency/space, RS control overhead, RS signaling overhead, etc. The gNB may transmit default RS configurations for AIML training.

In some embodiments, a UE may support AIML-based data-driven UE-specific RS processing (i.e., flexible RS operation), for example, using autoencoders (AE). Different types of AIML models (e.g., the AE) may be used for flexible RS operation. For example, a dedicated AIML model may be devised and trained to predict the preferred RS pattern and density across time/frequency/space, and a dedicated AIML may be used to compress the RS selection. A generalized model may also be designed to predict and compress the preferred RS selection. In another example, the AIML processing may be split between the UE/gNB, where an encoder model is devised and trained at the UE side, then with certain inter-node data exchange, the decoder at the gNB can extract the preferred RS selection.

In an embodiment, the UE may report its AIML-based data-driven UE-specific RS processing capability to the gNB, and may report the configured AIML model. The parameters that describe the UE RS processing model may include one or more of:
i. RS attributes in frequency domain—positions, resource block bundling, equal spacing, non-equal spacing, uniform, non-uniform, etc.
ii. RS attributes in time domain—positions, multi-slot bundling, equal spacing, non-equal spacing, uniform, non-uniform, etc.
iii. RS attributes in spatial domain—orthogonal cover code, spatial multiplexing, MU-MIMO.
iv. RS joint gNB/UE processing;
V. Non-deterministic RS processing capability; and/or
vi. Non-orthogonal RS processing capability.

In an embodiment, the UE may also indicate its CEST processing type to the gNB. The CEST processing type may include one or more of:
i. Time domain CEST;
ii. Frequency domain CEST; and/or
iii. Time and frequency domain CEST.

In an embodiment, the UE may also indicate its CEST algorithm type to the gNB. The CEST algorithm type may include one or more of: MMSE, LS, AIML based, etc.

According to certain embodiments, an AIML-capable UE may be configured by the gNB (high-layer configuration or scheduling-based) with required data-driven UE-specific RS design attributes for selection and feedback. For example, the configuration and feedback may be for selection of flexible non-uniform RS patterns across multiple frequency and time resources, or a subset of attributes, e.g., equally-spaced or non-equally-spaced uniform RS patterns.

In some embodiments, the gNB configuration may choose the degrees of freedom for selection based on UE capability, performance requirements, MU-MIMO situation, etc. For instance, the gNB may set a specific minimum/maximum RS density in time, frequency, or both for RS selection. The gNB may set a range of resource blocks and/or slots for frequency and time domain bundling for UE to select from. The gNB may set a specific (maximum) signaling load for feedback of UE-specific RS design.

According to an embodiment, the gNB may transmit default user-specific RS for CEST, coherent demodulation, and/or AIML model training, where default design may be legacy (e.g., NR Types 1 and 2), new RS patterns including additional NR Types (e.g., a Type X), or new non-uniform options.

In one embodiment, the default configuration may be new non-deterministic (random) RS pattern, which can be near-optimal for certain receiver types (e.g., MMSE). This can be a low-overhead option where AIML model may be used to indicate higher/lower density for the random RS pattern (as opposed to selecting specific locations). In one example, the gNB may calculate the random RS pattern and configure the UE with the exact locations/pattern/density of the RS in time/frequency/space using high-layer signaling (RRC), or dynamic signaling (MAC-CE, DCI, etc.). In one example, the UE can carry out the CEST with the random RS pattern, where iterative processing can be used to determine the locations of the pilots prior to interpolation/extrapolation operations. In one example, the gNB may calculate the random RS pattern and signals the seed value used, or equivalent statistical value, to the UE. The UE can utilize this information to determine the locations of the pilots (through iterative processing), after which it proceeds with the CEST operation.

An embodiment may utilize a non-orthogonal RS pattern where the default configuration is new superimposed RS with energy for the REs split between a pilot symbol and a data symbol. In this example, the AIML model, e.g., gNB-based processing, UE-based processing or joint UE/gNB-based processing, may be used to learn the amount of energy that should be allocated to pilots (i.e., determining a pilot allocation matrix). In one example, end-to-end learning may be used where the gNB calculates the superimposed pilot allocation matrix based on the received CSI, and feeds back the matrix as part of the input into the CEST AIML model at the UE, for maximizing certain performance (error rate, throughput, etc.). In one example, end-to-end learning may be used, where the UE, using iterative receiver or equivalent, can calculate the superimposed pilot allocation matrix and feeds back the matrix as part of the CSI compression report, where the pilot allocation matrix is used as an input to the CEST AIML model at the gNB, for maximizing certain performance (error rate, throughput, etc.). In one example, the UE may be configured with an AIML-based model trained to compute the compressed inter-node data required to calculate the superimposed pilot allocation matrix at the decoder (gNB).

### Representative Procedures to Determine UE-Specific RS

In an embodiment, a UE may be configured to determine and report a new RS pattern based on PDSCH performance, or receiver complexity (i.e., number of available computation resources), or signaling overhead, or any combination thereof.

For the AIML model, the input may be the effective channel matrices from the resource grids and the output may be the data-driven UE-specific RS design based on the gNB configuration involving one or any design attribute combinations and realizations including position/pattern in frequency and time resources, bundling across multiple frequency and time resources, etc. For example, an AIML model may be trained offline or online with the following attributes:
a) Input: a set of effective channel matrices; from one or multiple slots, resource blocks, etc. Input may also include specific design attribute specifics such as maximum allowed density in time, frequency, maximum allowed signaling overhead, etc.
b) Output: bundling type and/or position, pattern, and/or density for UE-specific RS pattern based on performance objectives such as improving CEST accuracy, reducing signaling overhead, reducing receiver complexity, etc.

As one pilot pattern design example, consider a time-frequency grid of 12 subcarriers and 14 symbols, where the maximum overhead for (orthogonal) RS is 16. Hence, there are (₁₆^{12×14}) pilot pattern combinations (which is a huge search space). A data-driven approach here can be used to obtain near-optimal pattern for specific channel models. The input is the estimated effective channels (using default RS configuration) where there is a DNN with a multi-stage process to: (1) extract features related to preferred locations of the pilots (e.g., based on correlations in time/frequency), and/or (2) predict/estimate CEST performance with selected pattern.

According to some embodiments, a UE may be configured to determine a new RS pattern based on the PDSCH performance. For example, the UE may recommend a RS pattern, such as a pattern with higher density or the same density but with different locations, if the block error rate (BLER) exceeds some preconfigured threshold. A UE may also determine a new RS pattern based on the receiver complexity. For example, based on the number of available computation resources, a UE may determine and recommend a pattern that reduces the receiver complexity, such as a pattern with lower density that essentially requires a small number of effective channel matrices computations. Thus, adding less weight to the effective channel matrices computations and more weight to the number of interpolations/extrapolations steps that are much computationally cheaper relative to the effective channel matrices estimation, so overall reducing the receiver complexity. A UE may also determine a pattern that can be signaled with minimal uplink signaling overhead.

In an embodiment, a UE may use an AI/ML model to determine a preferred UE-specific RS (e.g., DM-RS) configuration. The preferred UE-specific RS configuration may include a preferred RS pattern, a preferred density (in time and/or frequency domain), a preferred OCC, and/or a bundling type, and the like. The AI/ML model may be trained off-line and deployed to the UE, e.g., for inference during on-line operation. The AI/ML model may also be re-trained on-line. When the UE is configured with a UE-specific RS configuration (e.g., a default RS configuration, or a previously indicated preferred RS configuration), the UE estimates the effective channel using the received RS at the configured RE locations. The UE may then perform interpolation to determine the full effective channel matrix at all RE locations within the PRBs in the allocated transmission bandwidth. The full/full effective channel matrix may be vectorized or reshaped before being applied at the input of the AI/ML model, e.g., to determine the preferred UE-specific RS configuration. The UE may report the determined preferred RS configuration to the gNB.

Alternatively, in an embodiment, the input to the AI/ML model can also be an array including a tuple of the channel estimate developed using the received RS at the configured RE locations and the coordinates of the RE location in the grid. This array may be zero padded to attain a predefined maximum length corresponding to the largest RS pattern or maybe treated as a sequence for recurrent neural network (RNN) styled AIML models.

According to certain embodiments, the UE may use an AI/ML model to determine the preferred UE-specific configuration. In one example, the UE may use the default RS configuration for the determination of the preferred RS configuration. The default RS configuration may refer to: a RS pattern in the time/frequency domain, or a new DM-RS pattern. For example, a RS pattern in the time/frequency domain may be a legacy DM-RS configuration (Type 1/Type 2, Mapping Type A/Mapping Type B, duration and number of additional DM-RS positions).

The preferred RS configuration may be one of the existing DM-RS configurations or an entirely new RS pattern. For instance, the UE may determine a new RS pattern from the existing patterns based on channel measurements (e.g., delay spread and Doppler spread) and signal back the new parameters required (e.g., number of additional DM-RS positions) for using this pattern in the next transmission slot.

When configured to use the default RS configuration for the determination of the preferred UE-specific RS configuration, the UE may be indicated the timing of the transmissions of the default RS configurations. For example, the default RS configuration may be periodic, semi-static or aperiodic. The UE may be signaled the RS configuration (may include the timing configuration, and periodicity), e.g., via RRC signaling. Alternately, the presence of the default RS configuration may be indicated via downlink control information (DCI).

In another example, the UE may use the current RS configuration (e.g., which may be a previously determined and configured preferred RS configuration) for the determination of the new or updated preferred RS configuration.

In an embodiment, the input to the AI/ML model may be the full or the full effective channel matrix, where ‘full’ refers to the channel determined for all the RE locations within the PRBs in the allocated transmission bandwidth, and ‘effective’ refers to the channel as experienced by the UE receiver, which includes the Tx precoding when precoding is applied.

According to certain embodiments, the UE may use the received RS (e.g., the default RS configuration or a selected preferred RS configuration), to perform channel estimation using the received RS, followed by channel interpolation to determine the full effective channel matrix. The full effective channel matrix may further be vectorized and reshaped, then applied to the input of the AI/ML model.

In some embodiments, in addition to the full effective channel matrix, other channel characteristics/parameters may be applied to the AI/ML model input. For example, the channel coherence bandwidth and/or the channel coherence time may be used as additional inputs, which may select for example the density of the preferred RS configuration in the frequency and/or time domain.

Alternatively, just the estimated channel at RS locations along with the coordinates of the RE corresponding to the RS may be used as the input to the AI/ML model. Such input may be particularly favorable for sequence-based AI/ML models.

The output of the AI/ML model may be a means to determine the preferred UE-specific RS configuration. For example, the AI/ML model output may be an index in a predefined table of RS configurations. Here, the overall problem may be cast as a classification problem to identify the next RS configuration. The AI/ML model may be comprised of two sequential models, whereby the first model uses the measured coherence time/coherence bandwidth and outputs an indication of preferred density (in time and/or frequency domain), and the second model outputs an index in the table of predefined RS configurations for the time/frequency density indicated by the first model. The AI/ML model output may be an indicator to increase or decrease the time and/or frequency density of the RS pattern. Different sparsity based formulations may also be utilized specially for decreasing the density of the RS pattern. The AI/ML model may also output a segmentation mask of the same size as the channel dimension, clustering/grouping the REs within the channel tensor that may have highly correlated channel measurements thus effectively indicating the regions that need only a single RS symbol per grouping/cluster to estimate the overall channel across the RS's within the group. The AI/ML model may also output a set of clusters/groups of variable size, probably in an unsupervised fashion, where the number of clusters represents the RS pattern length (number of reserved REs) and each cluster has its associated representative RE with effective channel matrix that is strongly correlated with the other REs in the same cluster. Additionally or alternatively, in some embodiments, the output of the AI/ML model may include an indication of at least one bundling type.

In one example, pruning techniques may be used to further reduce the pilot signals whilst maintaining certain CEST performance. In an embodiment, sparsity regularization techniques may be used by the DNN to further reduce the pilot signals whilst achieving certain trade-off between sparsity and MSE. The AI/ML model may provide an indication of the bundling across time and/or frequency.

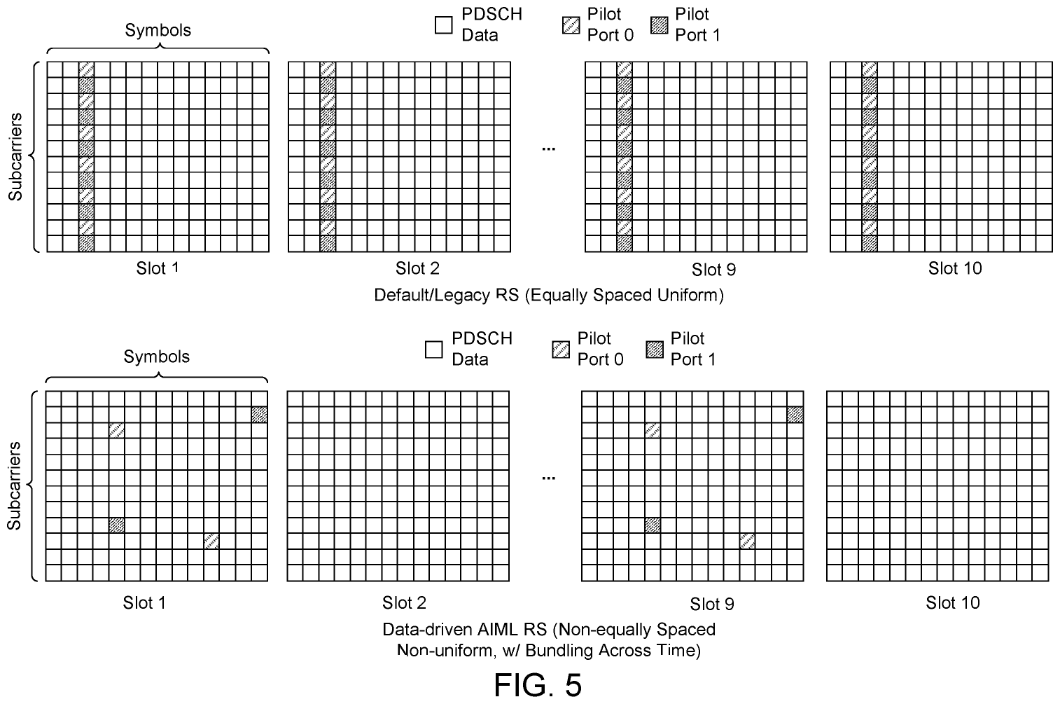

FIG. 5 illustrates an example of the AIML model-based RS selection, according to an embodiment. In the example of FIG. 5, the data-driven UE-specific RS is selected as a non-equally-spaced non-uniform pattern, with bundling across slots (here two).

According to some embodiments, the AI/ML model may be trained off-line and deployed to the UE, e.g., for inference during run-time. AI/ML models that use the full effective channel matrix as input may be trained off-line, for example, with synthetic training datasets obtained by applying predefined (e.g., legacy) precoding to generated channel samples. The corresponding outputs (e.g., RS pattern or index to a table of predefined patterns) may be determined according to an optimization criterion. For example, the optimization criterion may be to minimize the MSE between the interpolated channel and the true channel given a maximum RS overhead.

In certain embodiments, the AI/ML model may be re-trained on-line. For example, the UE may be configured with labeled outputs (for the AI/ML model) corresponding to specific training RS configurations. When the gNB configures the UE for on-line training, the gNB may transmit the training RS configuration, and the UE can use the received RS to perform channel estimation, interpolation and use the interpolated channel jointly with the configured labeled output to re-train the model.

### Representative Procedures to Indicate UE-Specific RS

According to an embodiment, the UE may indicate or determine the configuration of the DM-RS configuration (e.g., pattern, location, etc.) and may then report it to the gNB. The UE may feedback the DM-RS configuration implicitly, explicitly or using inter-node exchange, data-driven UE-specific RS design including cases for pilot-less transmission (for x number of upcoming slots or starting x transmission in time).

The UE may receive an indication to configure the data driven UE-specific RS, which may be included in, e.g., DCI, MAC-control element (CE) or RRC. Upon receiving the indication, the UE may indicate to the gNB a new model type, or a modified model for processing the data driven UE-specific RS based on the gNB configuration involving one or any design attribute combinations and realizations including position/pattern in frequency and time resources, bundling across multiple frequency and time resources.

The UE may use the default pilots to decode the resource grid, then may perform extra processing by feeding the estimated channel into the AI/ML encoder. The output of the encoder may have information on the preferred locations for pilots within the resource grid. In an example embodiment, the UE may construct a bit map describing a non-uniform pilot allocation, which may be a matrix of zeros and ones (e.g., representing the time-frequency grid of 12 subcarriers and 14 symbols). In this embodiment, the positions of ones in the grid may indicate the location of the pilots in the next resource grid. In another embodiment, the UE may construct a string of indices that includes the symbol indices and the subcarrier indices of the preferred locations of the pilots.

The UE may report or indicate the constructed patterns of REs for one or several RBs/slots, using string of such indices, with DM-RS locations for OFDM symbol index, subcarrier index, antenna port, etc. The indication may be the recommended number of RBs and/or slots for bundling in time/frequency. The resource bundling may also extend to pilotless transmission, where the UE may indicate to the gNB an option for pilotless transmission. In this case, the UE may use the AIML model to predict effective channel characteristics. For resource bundling (both with pilot or pilotless transmission), the UE may indicate the properties of the user-specific RS bundle. For example, the properties of the user-specific RS bundle may include: the number of transmissions (ex. N RBs); the effective duration of the constructed pattern; the ports where the constructed pattern is applicable; and/or the type of transmission (ex. N consecutive RBs/slots or N non-consecutive RBs/slots).

In one example, the UE may receive an indication requesting dynamic resource block bundling. The UE may determine the condition to apply to dynamic RB bundling based on the input effective channel matrix for S subcarriers (e.g., sets of 12 OFDM subcarriers). In an example embodiment, the UE may determine a set of physical resource blocks that can be bundled together for CEST. For instance, after detecting a correlation between multiple channels, the UE may assign a reduced number of pilots in a reduced number of sub-bands. In another example, the UE may receive an indication requesting dynamic slot bundling. The UE may determine the condition to apply dynamic slot bundling based on the input effective channel across multiple (time) slots. For instance, after detecting a correlation between channels across multiple slots, the UE may assign a reduced number of pilots in a reduced number of slots. In another solution, the UE determines dynamic bundling across frequency and time for RS selection towards CEST in a future determined time instance.

The data driven user-specific RS may be reported explicitly through PUCCH, or PUSCH, based on configured time domain behavior (periodically, semi-periodically, or periodically). The UE-specific RS reporting is applicable to any AI/ML model, where the AI/ML model may be configured by the network, or specific for each UE. A UE may be configured to report the AI/ML model specific, such as the NN architecture and weights.

The UE may receive an indication to perform joint processing between the gNB and the UE. Upon receiving the indication, the UE may utilize an AIML model (encoder) to process certain assessment of the channels, and/or identification of an optimized RS characteristic for use in subsequent transmissions, and may feedback this internode data to the gNB. In one example, the UE may extract the channel features, such as inherent time/frequency/space correlations across REs, symbols, and antennas, that can be used to predict the preferred RS. The gNB may use this information to determine the data driven user-specific RS. After determining the user-specific RS, the gNB indicates to the UE the obtained pilot map.

### Representative Procedures For Performance Monitoring and Triggers for UE-Specific RS

According to some embodiments, a UE may monitor the performance of an RS pattern (e.g., DL or UL DM-RS pattern) or a parameter of an RS pattern. The UE may determine an absolute performance (e.g., a granular performance level) or a relative performance. The relative performance may be compared to a threshold (e.g., a configurable threshold). For example, if the performance is greater than a threshold, the UE may deem the RS pattern or parameter of an RS pattern to be valid or adequate or accurate or suitable. If the performance is less than a threshold, the UE may deem the RS pattern or parameter of an RS pattern to be invalid or inadequate or inaccurate or unsuitable. The UE may determine a threshold from a gNB indication. The threshold may be determined as a function of at least one of: associated data type, priority level of the associated data, frequency allocation, time allocation, RS pattern density, and/or UE capability (e.g., channel estimation capability).

In an embodiment, a UE may be triggered to determine and/or report the performance of an RS pattern or parameter of an RS pattern. The triggers may include at least one of:
i. Indication received from gNB. The indication may be PHY layer (E.g. DCI or MAC CE) or higher layer signaling (e.g. RRC);
ii. Upon configuration or reconfiguration of a new RS pattern;
iii. At specific time instances. For example, the UE may monitor or report the performance at periodic times or slots or subframes or symbols;
iv. Upon expiration of a timer. For example, a UE may maintain a timer and when the timer expires, the UE may monitor or report the performance of an RS pattern or parameter of an RS pattern. The UE may (re)start a timer when it is configured with a new RS pattern or when it reports a performance. The UE may (re)start a timer when a specific instance of an RS pattern is deemed valid or invalid. For example, the UE may (re)start a timer when a transmission is acknowledged (ACKed) or negative acknowledged (NACKed). The UE may (re)start a timer when the performance of an RS pattern is deemed valid or invalid for one or more associated transmissions.
v. Based on a counter. A UE may determine or report the performance of an RS pattern when a counter reaches a possibly configurable value N. The UE may increment the counter when a specific instance of an RS pattern is deemed invalid or valid. For example, the UE may increment a counter when a transmission is ACKed or NACKed. A UE may reset a counter when a timer expires; and/or
vi. Change in BWP.

In certain embodiments, a UE may monitor and/or determine the performance of an RS pattern. The performance may be determined by at least one of:
i. Performance of the Channel Estimator (CHEST). For example, a UE may determine the performance of the CHEST on a first RS pattern based on the output of a second (possibly denser) RS pattern. For example, the UE may determine a statistical performance of the CHEST on an RS pattern. For example, the UE may determine the average error (e.g., MMSE) of a CHEST on an RS pattern. In an example, the UE may report the convergence of the CHEST or statistics of the CHEST (e.g., mean or variance);
ii. BLER. For example, the UE may determine the performance of an RS pattern as a function of the BLER of associated data transmissions. An RS pattern may be deemed valid if the BLER is below a threshold value and invalid if the BLER is above a threshold value;
iii. HARQ-ACK statistics of the associated data transmissions. For example, if the percentage of NACKs over a possibly configurable period of time is greater than a threshold, the UE may determine the performance of the RS pattern to be invalid. If the percentage of NACKs over a possibly configurable period of time is less than a threshold, the UE may determine the performance of the RS pattern to be valid. In another example, the performance of an RS pattern may be the percentage of NACKs or ACKS over a possibly configurable period of time;
iv. Based on a measurement. For example, the UE may determine the performance of an RS pattern as a function of at least one of: RSRP, RSSI, RSRQ, CO, CQI, PMI, RI, LI, CRI, doppler spread, doppler shift, average delay, delay spread, LOS or NLOS, Probability of LOS; and/or
v. Based on the performance of a transmission. For example, the UE may determine the performance of an RS pattern based on the throughput, latency, spectral efficiency, time/frequency allocation of one or more transmissions.

In an embodiment, a UE may report the performance of an RS pattern or a parameter of an RS pattern. The report may include absolute performance or relative performance (e.g., relative to a threshold). The report may include at least one of:
i. The outcomes of the above methods (e.g., CHEST performance, BLER, HARQ-ACK statistics, measurements). The report may include the actual value or an outcome (e.g., valid or invalid) of a comparison with a threshold. The report may include the threshold used (e.g., an index of the threshold used);
ii. A request for a new pattern. For example, if the UE determines an RS pattern is not suitable, it may request the gNB for a new pattern. The request may include a cause. The cause may include the measurement or statistic that led to the determination that the RS pattern is not suitable;
iii. A request for an increase or decrease in RS density. The request may be granular. For example, the UE may indicate where density should be increased or decreased (e.g., what time occasions or what subcarriers/frequency region);
iv. A request to retrain the CHEST AIML model. For example, the UE may request resources or signals to retrain the CHEST model for that RS pattern or for a new RS pattern or to determine a new RS pattern;
v. A request for legacy based RS. For example, the UE may request to fall back to legacy DM-RS patterns;
vi. A request to start using UE-specific (e.g., AIML based) RS pattern;
vii. A report indicating the performance of pilotless transmissions. Herein, pilotless transmission may be considered as an RS pattern; and/or
viii. A report indicating the performance of random pilot transmission or RS pattern. The report may include a UE's determination or assumption of the random RS pattern used for one or more transmissions. For example, a UE may receive a transmission with a random RS pattern and the UE may determine or assume the RS pattern or a parameter of the RS pattern (e.g., the density of the RS or the locations of the RS). The UE may report the detected or assumed RS pattern or parameter of the RS pattern. The UE may also report the performance of the detected or assumed RS pattern.

According to some embodiments, a UE may be configured with one or more resources on which to report the performance of one or more RS pattern(s). The resource may be periodic, semi-persistent (e.g., activated or deactivated via a reporting trigger listed above) or aperiodic (e.g., indicated in a reporting trigger mechanism). The report resource may include at least one of:
i. Dedicated UL resource. For example, the UE may be configured with PUCCH resources to report the performance of an RS pattern;
ii. UCI in PUSCH. For example, the UE may report the performance of an RS pattern in a PUSCH transmission;
iii. UL MAC CE; and/or
iv. Part of HARQ feedback. For example, a UE may report the performance of an RS pattern in a HARQ feedback report. The UE may report the performance of an RS pattern associated with a set of transmissions (e.g. associated with a set of HARQ-ACK values). For example, for a set of ACK-NACK values, the UE may report the performance of an associated RS pattern. In an example, the UE may report the performance of an RS pattern for ACKed transmissions only or NACKed transmissions only. In an example, the type of performance reported may be determined based on if an associated transmission is ACKed or NACKed.

In one embodiment, a UE may include the performance of an RS pattern in a HARQ-ACK report or in a subsequent/associated reporting resource, if the number of NACKs in a HARQ-ACK report is greater than a threshold. The threshold may be an absolute number or a rate of NACKs to ACKs, for example.

According to some embodiments, a UE may determine that an RS pattern is valid based on its performance. The UE may continue using the RS pattern for UL transmissions or may expect to receive DL transmissions using the RS pattern. A UE may select or perform at least one of the following behaviors, possibly based on the performance of the RS pattern (e.g., determining that an RS pattern is not valid):
i. Retrain an AIML model. The UE may retrain an AIML model at the UE. The UE may transmit signals to enable a gNB to retrain an AIML model at the gNB;
ii. Receive or transmit one or more Reference Signal(s). For example, upon determining or reporting the performance of an RS pattern, a UE may begin receiving and measuring AIML model retraining RS. The UE may use measurements obtained on AIML model retraining RS to retrain an AIML model. The AIML model retraining RS may be coded RS (e.g. coded with a specific beam or pre-coding matrix). The coding of a specific instance of an RS may be known at the UE or indicated in a transmission associated with the RS transmission. For example, the coding may reuse the pre-coding used for a most recent RS or data transmission. For example, the coding may be determined by the timing of the RS transmission. For example, the coding may be determined by a pre-determined hopping pattern. The AIML model retraining RS may be transmitted without associated data;
iii. Switch to legacy RS behavior and patterns. For example, a UE may start transmitting UL DM-RS using a legacy RS pattern. In another example, a UE may expect subsequent DL transmissions to use legacy RS patterns;
iv. Switch from one type of RS pattern to another. For example, if the UE is operating with pilot-less transmissions, the UE may switch to pilot-based transmissions. In another example, a UE operating with an RS pattern of a first (e.g. lower) density may switch to an RS pattern of a second (e.g. higher) density;
v. Retransmission of a TB using legacy DM-RS;
vi. Monitor for an indication from the gNB of change in, or new, RS pattern(s); and/or
vii. Transmission of a desired RS pattern or RS pattern parameter.

### Example Implementation

According to an example embodiment, a UE or WTRU, such as a UE/WTRU with data-driven UE/WTRU-specific RS design capability, may be configured to indicate its capability to a network element, such as a base station or gNB (e.g., as part of UE capability signaling). The UE/WTRU may be configured to receive configuration information related to AIML RS design processing (e.g., if not legacy) from the network element (e.g., base station, gNB or the like) including one or any combination of attributes. For example, the attributes may include one or more of: Position/pattern in frequency or/and time resource; bundling across multiple frequency or/and time resources; maximum allowed density in time or/and frequency; MU-MIMO settings (e.g., CDM muting); maximum allowed signaling feedback; and/or performance requirements (e.g., CEST accuracy threshold, receiver processing complexity, etc.).

In an embodiment, the UE/WTRU may be configured to receive default RS transmission from the network element (e.g., base station, gNB or the like) based on any of the following options. For example, the received default RS transmission may be based on one or more options that may include: NR legacy DM-RS (e.g., Types 1 and 2, Mapping Type A or Type B, etc.); new uniform RS pattern (e.g., Type X with different frequency resource RS insertion); new (deterministic) non-uniform RS pattern; new (random) non-uniform RS pattern; and/or new non-orthogonal RS pattern (superimposed pilots).

According to an embodiment, the UE/WTRU may be configured to determine data-driven UE-specific RS design based on the signaled attributes by using an AIML model. In certain embodiments, the AIML model can be trained, for example, with at least the following labelled data:
Input: effective channel matrices, from one or multiple slots, resource blocks, etc. ; attributes for RS design selection (patterns, maximum bundling values, etc.).
Output: bundling type (e.g., an indication of at least one bundling type) and/or position, pattern, and/or density for UE-specific RS pattern based on performance objectives such as improving CEST accuracy, reducing signalling overhead, reducing receiver complexity, etc.

In an embodiment, the UE/WTRU may be configured to send feedback (periodically or semi-periodically), implicitly, explicitly, or using inter-node data exchange (e.g., for AIML joint processing cases), to the network element (e.g., base station, gNB or the like) for the UE-specific RS design to use in subsequent payloads or transmissions (e.g., future transmission of the indicated RS to begin within X time-unit from a reference point in time). As an example, triggers for (aperiodic) indication may include assessing CEST performance accuracy against certain threshold(s), and/or assessing channel statistics (coherence interval) against certain threshold(s), etc. For example, in some embodiments, the sending of feedback may be triggered when CEST performance meets certain threshold(s) and/or when channel statistics meet certain threshold(s).

According to an embodiment, if the UE/WTRU determines that the requested data-driven UE/WTRU-specific RS design has not been activated within a configured time window, it may interpret it as a decoding failure at the network element (e.g., base station, gNB or the like), and may re-transmit the indication. In one example, the UE/WTRU may indicate to the network element (e.g., base station, gNB or the like) an option for pilotless transmission, with the AIML model used to predict effective channel characteristics.

According to some embodiments, data-driven UE-specific transmission can continue if/until performance falls below threshold, where the AIML model may benefit from retraining, or channel quality is poor such that it would benefit from switching to legacy operation.

### Example Method

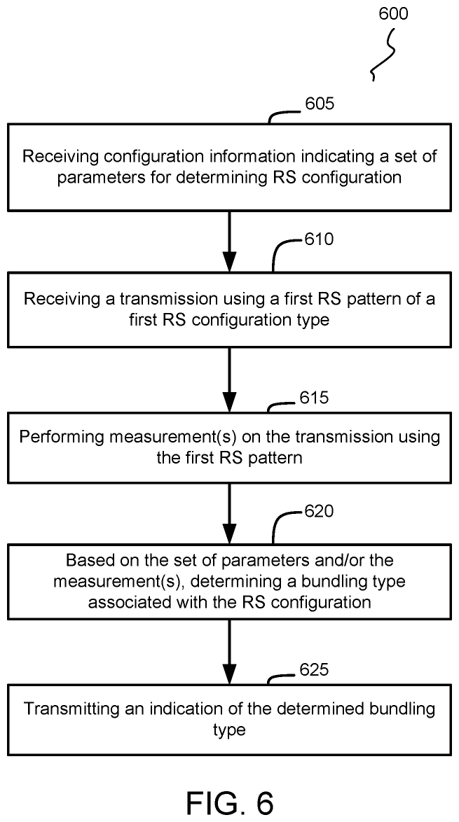

FIG. 6 is an example flow diagram illustrating an example method 600 of configuring, selecting and/or feeding-back UE-specific RS information, according to some example embodiments. The example method of FIG. 6 and accompanying disclosures herein may be considered a generalization or synthetization of the various disclosures discussed above. For convenience and simplicity of exposition, the example of FIG. 6 may be described with reference to the architecture described with respect to FIG. 1 or 4, for instance. However, the example method depicted in FIG. 6 may be carried out using different architectures as well. According to some embodiments, the method of FIG. 6 may be implemented by a UE or WTRU, such as the WTRU 102 described in the foregoing. It is noted that the method and/or blocks of FIG. 6 may be modified to include, or to be replaced by, any one or more of the procedures or blocks discussed elsewhere herein. As such, one of ordinary skill in the art would understand that FIG. 6 is provided as one example and modifications thereto are possible while remaining within the scope of certain example embodiments.

As illustrated in the example of FIG. 6, the method 600 may include, at 605, receiving, by the WTRU, configuration information that may include or indicate any of: a set of parameters for determining a reference signal (RS) configuration and, optionally, a parameter to use within the set. As one example, the set of parameters may include at least two bundling types. In further examples, the set of parameters may additionally or alternatively include any one or more of: a RS position, RS pattern, maximum allowed RS density, minimum allowed RS density, multi-user multiple input multiple output (MU-MIMO) setting, RS configuration signaling feedback overhead, and performance requirements.

In certain embodiments, the method 600 may also include, at 610, receiving a transmission using a first RS pattern of a first RS configuration type. For example, the first RS configuration type may include one or more of: new radio (NR) legacy demodulation reference signals (DM-RS), a uniform RS pattern, a deterministic non-uniform RS pattern, a random non-uniform RS pattern, and/or a non-orthogonal RS pattern.

According to some embodiments, the method 600 may then include, at 615, performing one or more measurements on the transmission using the first RS pattern. For example, the one or more measurements may include measurements relating to one or more of: an effective channel matrix for one or more slots or resource blocks, channel estimation accuracy, and/or RS signaling overhead.

According to an embodiment, the method 600 may include, at 620, determining a bundling type associated with the RS configuration, based at least on part on the set of parameters and/or the one or more measurements. In one example, the determining 620 of the bundling type may include determining or selecting the bundling type from among the at least two bundling types included in the set of parameters. In an embodiment, the determining 620 of the bundling type may include determining or selecting the bundling type based on other criteria, such as the measurements performed on the received transmission. At 625, the method 600 may include transmitting a first indication of the determined bundling type. As an example, in one embodiment, the bundling type may indicate resource bundling properties across one or more of time and/or frequency.

In some embodiments, the determining 620 of the bundling type may be performed using an AI/ML model as discussed in detail above.

In certain embodiments, although not illustrated in the example of FIG. 6, the method 600 may include determining one or more of a second RS pattern and a second RS configuration type, based at least on the set of parameters and/or the one or more measurements, and transmitting a second indication of the determined one or more of the second RS pattern and the second RS configuration type. According to an example embodiment, one or more of the second RS pattern and/or the second RS configuration type may be determined using an AI/ML model.

In some example embodiments, the AI/ML model may be trained with labelled data comprising input and output. For example, the input may include one or more of: (i) the effective channel matrix for one or more slots or resource blocks, and/or (ii) the set of parameters for determining the RS configuration. The output may include the bundling type (e.g., an indication of at least one bundling type) and/or one or more of the position, pattern, and/or density for the second RS pattern based on performance objectives.

According to some embodiments, the transmitting of the first indication and/or the second indication may include: implicitly transmitting one or more of the first indication and the second indication, explicitly transmitting one or more of the first indication and the second indication, transmitting one or more of the first indication and the second indication using inter-node data exchange, periodically transmitting one or more of the first indication and the second indication, and/or semi-periodically transmitting one or more of the first indication and the second indication.

According to an example embodiment, the transmitting of the second indication may be triggered based on one or more of: channel estimation performance accuracy meeting at least one threshold, and/or channel statistics meeting at least one threshold.

### Conclusion

The contents of each of the following references is incorporated by reference herein in its entirety: (1) 3GPP TS 38.214, “Physical layer procedures for data”; (2) 3GPP TS 38.213, “Physical layer procedures for control”; (3) 3GPP TS 38.212, “Multiplexing and channel coding”; (4) 3GPP TS 38.211, “Physical Channels and Modulation”; (5) 3GPP TS 38.331, “Radio Resource Control (RRC) protocol specification”; (6) 3GPP TS 38.321, “Medium Access Control (MAC) protocol specification”; and (7) 3GPP TS 38.215, “Physical layer measurements”.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of infrared capable devices, i.e., infrared emitters and receivers. However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only, and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only, and should not be taken as limiting the scope of the following claims. For instance, the embodiments provided herein include handheld devices, which may include or be utilized with any appropriate voltage source, such as a battery and the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be effected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations.

In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

Furthermore, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶6 or means-plus-function claim format, and any claim without the terms “means for” is not so intended.

1. A method, comprising:
receiving, by a wireless transmit/receive unit (WTRU), configuration information indicating (1) a set of parameters for determining a reference signal (RS) configuration and (2) a parameter to use within the set, wherein the set of parameters comprise at least two bundling types;
receiving a transmission using a first RS pattern of a first RS configuration type;
performing one or more measurements on the transmission using the first RS pattern, wherein the one or more measurements include any of: an effective channel matrix for one or more slots or resource blocks, channel estimation accuracy, and RS signaling overhead;
determining a bundling type associated with the RS configuration, based on (i) the set of parameters and (ii) the one or more measurements; and
transmitting a first indication of the determined bundling type.

2. The method of claim 1, wherein the bundling type indicates resource bundling properties across one or more of time and frequency.

3. The method of claim 1, wherein the determining of the bundling type is performed using an artificial intelligence/machine learning (AI/ML) model.

4. The method of claim 1, wherein the set of parameters further comprise one or more of: a RS position, RS pattern, maximum allowed RS density, minimum allowed RS density, multi-user multiple input multiple output (MU-MIMO) setting, RS configuration signaling feedback overhead, and performance requirements.

5. The method of claim 1, comprising:
determining one or more of a second RS pattern and a second RS configuration type, based on (i) the set of parameters and (ii) the one or more measurements; and
transmitting a second indication of the determined one or more of the second RS pattern and the second RS configuration type.

6. The method of claim 5, wherein one or more of the second RS pattern and the second RS configuration type is determined using an artificial intelligence/machine learning (AI/ML) model.

7. The method of claim 6, wherein:
the AI/ML model is trained with labelled data comprising input and output,
the input comprises one or more of: (i) the effective channel matrix for one or more slots or resource blocks, and (ii) the set of parameters for determining the RS configuration, and
the output comprises one or more of: the bundling type, position, pattern, and density for the second RS pattern based on performance objectives.

8. The method of claim 1, wherein the first RS configuration type comprises one or more of:
new radio (NR) legacy demodulation reference signals (DM-RS);
a uniform RS pattern;
a deterministic non-uniform RS pattern;
a random non-uniform RS pattern; and
a non-orthogonal RS pattern.

9. The method of claim 1, wherein transmitting the first indication or the second indication comprises:
implicitly transmitting one or more of the first indication and the second indication;
explicitly transmitting one or more of the first indication and the second indication;
transmitting one or more of the first indication and the second indication using inter-node data exchange;
periodically transmitting one or more of the first indication and the second indication; or
semi-periodically transmitting one or more of the first indication and the second indication.

10. The method of claim 1 , wherein the transmitting of the second indication is triggered based on one or more of: (i) channel estimation performance accuracy meeting at least one threshold, and (ii) channel statistics meeting at least one threshold.

11. A wireless transmit/receive unit (WTRU) comprising:
circuitry including any of a processor, memory, transmitter and receiver, the circuitry configured to:
receive configuration information indicating (1) a set of parameters for determining a reference signal (RS) configuration and (2) a parameter to use within the set, wherein the set of parameters comprise at least two bundling types;
receive a transmission using a first RS pattern of a first RS configuration type;
perform one or more measurements on the transmission using the first RS pattern, wherein the one or more measurements include any of: an effective channel matrix for one or more slots or resource blocks, channel estimation accuracy, and RS signaling overhead;
determine a bundling type associated with the RS configuration, based on (i) the set of parameters and (ii) the one or more measurements; and
transmit a first indication of the determined bundling type.

12. The WTRU of claim 11, wherein the bundling type indicates resource bundling properties across one or more of time and frequency.

13. The WTRU of claim 11, wherein the bundling type is determined using an artificial intelligence/machine learning (AI/ML) model.

14. The WTRU of claim 11, wherein the set of parameters further comprise one or more of: a RS position, RS pattern, maximum allowed RS density, minimum allowed RS density, multi-user multiple input multiple output (MU-MIMO) setting, RS configuration signaling feedback overhead, and performance requirements.

15. The WTRU of claim 11, wherein the circuitry is configured to:
determine one or more of a second RS pattern and a second RS configuration type, based on (i) the set of parameters and (ii) the one or more measurements; and
transmit a second indication of the determined one or more of the second RS pattern and the second RS configuration type.

16. The WTRU of claim 15, wherein the circuitry is configured to determine one or more of the second RS pattern and the second RS configuration type using an artificial intelligence/machine learning (AI/ML) model.

17. The WTRU of claim 16, wherein:
the AI/ML model is trained with labelled data comprising input and output,
the input comprises one or more of: (i) the effective channel matrix for one or more slots or resource blocks, and (ii) the set of parameters for determining the RS configuration, and
the output comprises one or more of: the bundling type, position, pattern, and density for the second RS pattern based on performance objectives.

18. The WTRU of claim 11, wherein the first RS configuration type comprises one or more of:
new radio (NR) legacy demodulation reference signals (DM-RS);
a uniform RS pattern;
a deterministic non-uniform RS pattern;
a random non-uniform RS pattern; and
a non-orthogonal RS pattern.

19. The WTRU of claim 11, wherein the circuitry is configured to:
implicitly transmit one or more of the first indication and the second indication;
explicitly transmit one or more of the first indication and the second indication;
transmit one or more of the first indication and the second indication using inter-node data exchange;
periodically transmit one or more of the first indication and the second indication; or
semi-periodically transmit one or more of the first indication and the second indication.

20. The WTRU of claim 11, wherein transmitting the second indication is triggered based on one or more of: (i) channel estimation performance accuracy meeting at least one threshold, and (ii) channel statistics meeting at least one threshold.
